(19) United States
(12) Patent Application Publication
(10) Pub. No.: US 2022/0405964 A1
(43) Pub. Date: Dec. 22, 2022

(54) OBJECT RECOGNITION APPARATUS AND NON-TRANSITORY RECORDING MEDIUM STORING COMPUTER READABLE PROGRAM

(71) Applicant: Konica Minolta, Inc., Tokyo (JP)

(72) Inventors: Daichi Suzuki, Toyokawa shi (JP); Yoshiyuki TOSO, Toyokawa shi (JP); Yoshihiro Inagaki, Tokyo (JP); Yusuke MURAKAMI, Okazaki shi (JP)

(73) Assignee: Konica Minolta, Inc., Tokyo (JP)

(21) Appl. No.: 17/844,109

(22) Filed: Jun. 20, 2022

(30) Foreign Application Priority Data
Jun. 22, 2021 (JP) 2021-102933

(51) Int. Cl. G06T 7/73; G06V 10/70

(52) U.S. Cl. CPC G06T 7/74; G06V 10/70

(57) ABSTRACT

An object is captured in an image taken by the camera. An external shape of the object is recognized from the image. An internal shape of the object is recognized from the image. Parts information of the object is then determined, using a result of the recognition of the external shape and/or a result of recognition of the internal shape.

This application claims priority to Japanese Patent Application No. 2021-102933, filed on Jun. 22, 2021, the entire disclosure of which is incorporated herein by reference in its entirety.

### BACKGROUND

### Technological Field

The present disclosure relates to recognizing of an object, using an image.

### Description of the Related Art

Conventionally, an image captured of an object is used to recognize the object. Various types of techniques are also proposed for recognizing an object using an image.

For example, Japanese Laid-Open Patent Publication No. H09-245177 discloses techniques for selecting optimal image recognition conditions for each part. More specifically, Japanese Laid-Open Patent Publication No. H09-245177 discloses setting, as recognition conditions, multiple types of workpiece imaging conditions (the angle and lighting intensity) and multiple types of processing conditions (pre-process and recognition process approaches for captured images) Image recognition process is then performed for each of the combinations of the types of imaging conditions and the types of processing conditions, and a combination having a minimum error is set as final recognition conditions.

### SUMMARY

Improvement in accuracy is constantly demanded for object recognition using an image, as described above.

According to a certain aspect of the present disclosure, an object recognition apparatus is provided for recognizing a state of an object, the object recognition apparatus including: a storage device; and one or more processors that execute a program stored in the storage device. The one or more processors: recognizes an external shape of the object, based on an image captured of the object, recognizes an internal shape of the object, based on the image captured of the object; and determines a state of the object, using a result of recognition of the external shape and a result of recognition of the internal shape.

According to another aspect of the present disclosure, a non-transitory recording medium storing a computer readable program is provided. The computer readable program, when executed by a computer, causes the computer to perform steps, including: recognizing an external shape of an object, based on an image captured of the object; recognizing an internal shape of the object, based on the image captured of the object; and determining a state of the object, using a result of recognition of the external shape and a result of recognition of the internal shape.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The advantages and features provided by one or more embodiments of the invention will become more fully understood from the detailed description given herein below and the appended drawings which are given by way of illustration only, and thus are not intended as a definition of the limits of the present invention.

FIG. 1 is a diagram schematically showing a configuration of a parts recognition system.

FIG. 2 is a diagram showing a hardware configuration of a recognition apparatus 100.

FIG. 3 is a diagram showing a functional configuration of the recognition apparatus 100.

FIG. 4 is a diagram illustrating one example of a data structure of an external-shape library.

FIG. 5 is a diagram illustrating one example of a data structure of an internal-shape library.

FIG. 6 is a flowchart of a process for the recognition apparatus 100 to output parts information of a part 400 placed on a tray 300.

FIG. 7 is a flowchart of Variation 1 of the process of FIG. 6.

FIG. 8 is a flowchart of Variation 2 of the process of FIG. 6.

FIG. 9 is a diagram showing a variation of the data structure of the external-shape library.

### DETAILED DESCRIPTION OF EMBODIMENTS

Hereinafter, one or more embodiments of the present invention will be described with reference to the drawings. However, the scope of the invention is not limited to the disclosed embodiments.

In the following, one embodiment of a parts recognition system will be described, with reference to the accompanying drawings. The parts recognition system is one example of a system which includes an object recognition apparatus. In the description below, the same reference sign is used to refer to like parts and components, which are assigned the same name and have the same function. Thus, descriptions of these will not be repeated.

[1. Parts Recognition System]

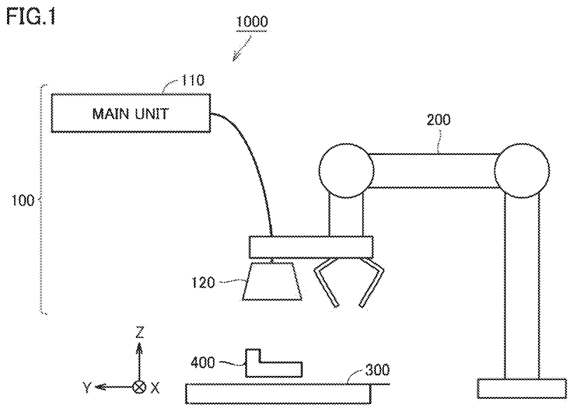

FIG. 1 is a diagram schematically showing a configuration of a parts recognition system. A parts recognition system 1000 is for determining a state of a part 400 placed on a tray 300.

The parts recognition system 1000 includes a robot arm 200 having a recognition apparatus 100 attached thereto. The recognition apparatus 100 is one example of an object recognition apparatus, and capable of communications with the robot arm 200.

The recognition apparatus 100 includes a main unit 110 and a camera 120. The main unit 110 determines a state of the part 400 placed on the tray 300, using an image captured by the camera 120. The part 400 is one example of an object. The image captured of the part 400 on the tray 300 is one example of an image captured of the object.

The recognition apparatus 100 may not include the camera 120. In other words, the recognition apparatus 100 may use an image captured of the part 400 on the tray 300 by an external device for the determination of the state of the part 400.

FIG. 1 shows three axes, which are X axis, Y axis, and Z axis. These three axes are used to refer to directions in the parts recognition system 1000. X axis and Y axis extend in directions along a resting surface of the tray 300. Z axis extends in a direction that intersects with the resting surface of the tray 300 (the vertical direction).

[2. Hardware Configuration]

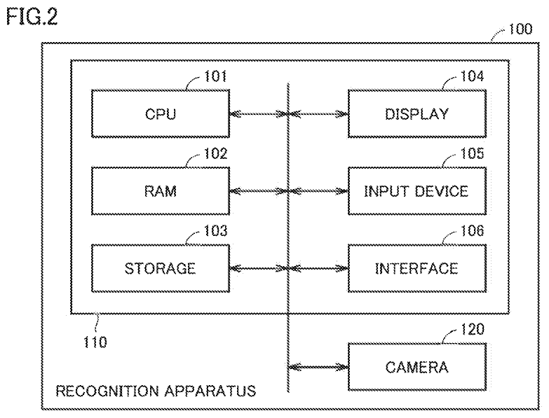

FIG. 2 is a diagram showing a hardware configuration of the recognition apparatus 100. The main unit 110 of the recognition apparatus 100 includes a central processing unit (CPU) 101, a random access memory (RAM) 102, a storage 103, a display 104, an input device 105, and an interface 106.

The CPU 101 executes a given program, thereby controlling the recognition apparatus 100. The RAM 102 functions as a work area for the CPU 101. The storage 103 is one example of a storage device. The storage 103 stores programs and/or data used to execute the programs. Note that the CPU 101 may execute programs stored in a memory device external to the recognition apparatus 100 or use data stored in a memory device external to the recognition apparatus 100.

The display 104 shows a result of operation by the CPU 101. The input device 105 is, for example, a keyboard and/or a mouse. The interface 106 is a communication interface and allows the recognition apparatus 100 to communicate with external devices.

[3. Functional Configuration]

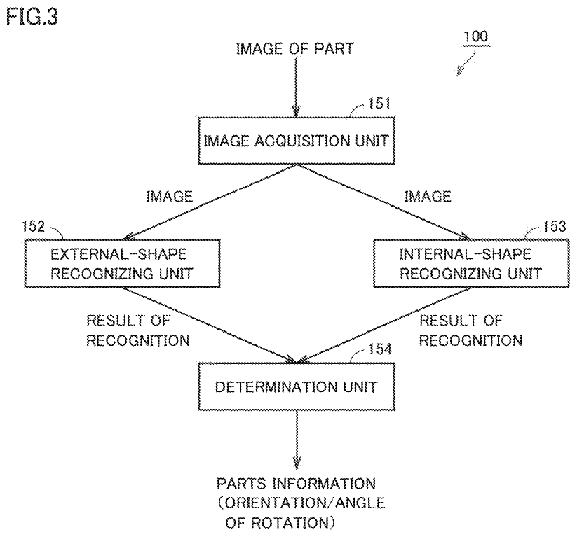

FIG. 3 is a diagram showing a functional configuration of the recognition apparatus 100. As shown in FIG. 3, the recognition apparatus 100 functions as an image acquisition unit 151, an external-shape recognizing unit 152, an internal-shape recognizing unit 153, and a determination unit 154. In one implementation, the image acquisition unit 151, the external-shape recognizing unit 152, the internal-shape recognizing unit 153, and the determination unit 154 are implemented by the CPU 101 executing a given program (e.g., an application program for parts recognition).

The image acquisition unit 151 obtains an image of the part 400. In one implementation, the camera 120 captures an image of the part 400 placed on the tray 300, thereby generating image data. The image acquisition unit 151 reads the image data generated by the camera 120, thereby obtaining the image.

The external-shape recognizing unit 152 recognizes the external shape of the part 400 from the image captured by the camera 120. In one implementation, the external-shape recognizing unit 152 determines whether the outer edge of an element recognized from the image matches an image pattern which is previously registered as the outer edge of a part. If there is a match, the external-shape recognizing unit 152 determines that the element captured in the image is that part.

The internal-shape recognizing unit 153 recognizes the internal shape of the part 400 from the image captured by the camera 120. In one implementation, the external-shape recognizing unit 152 determines whether the shape (structure) of a portion at an inner side of the outer edge of an element recognized from the image matches an image pattern previously registered as the internal structure of a part. If there is a match, the external-shape recognizing unit 152 determines that the element captured in the image is that part.

Using the result of recognition by the external-shape recognizing unit 152 and/or the internal-shape recognizing unit 153, the determination unit 154 determines parts information of the element in the image captured by the camera 120. In one implementation, the parts information includes the orientation and the angle of rotation of the part.

The orientation of the part refers to an orientation of the part 400 on the tray 300 relative to the camera 120. In one implementation, the orientation of the part is represented by a surface facing the camera 120 (front, rear, right, or left) among two or more surfaces of the part. The orientation of the part can be defined as a rotary position of the part 400 on the tray 300 about X axis and/or Y axis of FIG. 1.

The angle of rotation of the part can be defined as a rotary position of the part 400 on the tray 300 about Z axis of FIG. 1.

[4. External-shape Library]

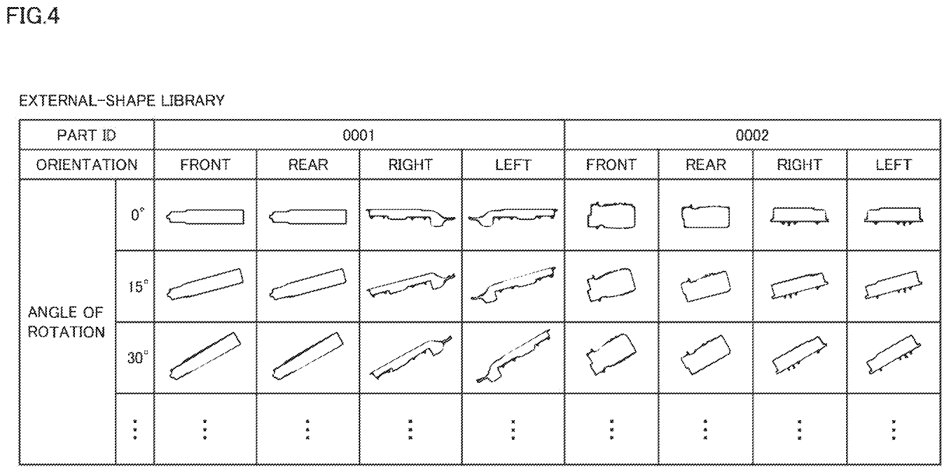

FIG. 4 is a diagram illustrating one example of a data structure of an external-shape library. The external-shape library is used by the external-shape recognizing unit 152 to recognize the external shape of a part.

As shown in FIG. 4, the external-shape library includes items “PART ID,” “ORIENTATION,” and “ANGLE OF ROTATION.” “PART ID” identifies respective parts that are handled by the parts recognition system 1000. In the example of FIG. 4, the information on two types of parts (PART ID “0001” and “0002”) are shown. The external-shape library includes four types of values (front, rear, right, and left) as “ORIENTATION,” and values representing angles of rotation (zero degree, 15 degrees, 30 degrees, . . . ) as “ANGLE OF ROTATION.”

The external-shape library includes information for each “PART ID.” The external-shape library includes image patterns representing the outer edge of a part. Each image pattern is associated with a combination of a value of “ORIENTATION” and a value of “ANGLE OF ROTATION”.

For example, the external-shape library includes an image pattern associated with a combination of the part ID “0001,” the orientation “FRONT,” and the angle of rotation “zero degree.” The external-shape library includes an image pattern associated with a combination of the part ID “0001,” the orientation “FRONT,” and the angle of rotation “15 degrees.” The image pattern registered with the external-shape library primarily represents the outer edge of a part.

[5. Internal-Shape Library]

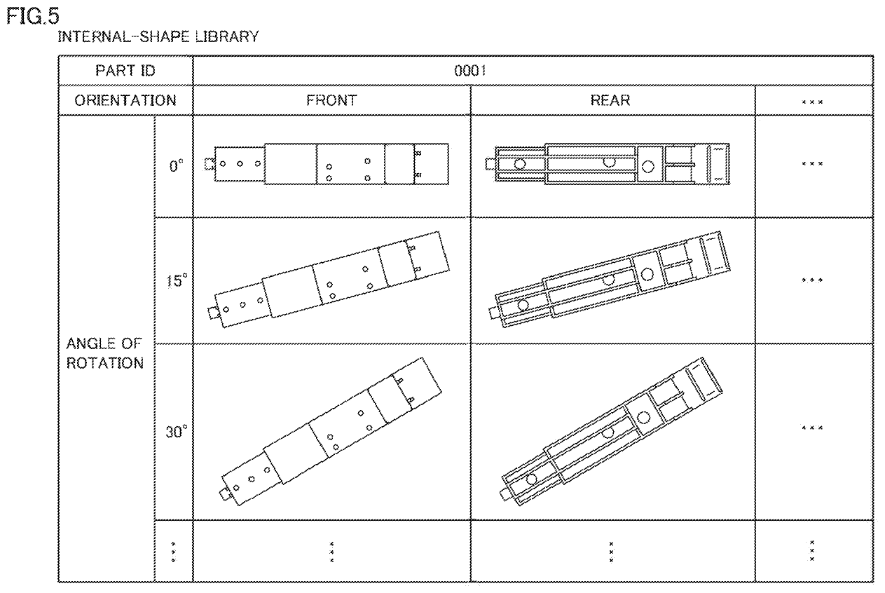

FIG. 5 is a diagram illustrating one example of a data structure of an internal-shape library. The internal-shape library is used by the internal-shape recognizing unit 153 to recognize the internal shape of a part. Due to space constraints, FIG. 5 only shows the information related to a portion of the part ID “0001.”

Similarly to the external-shape library, the internal-shape library also includes an image pattern representing the outer edge of a part for each “PART ID” in which the outer edge is associated with a combination of a value of “ORIENTATION” and a value of “ANGLE OF ROTATION.” The image pattern registered with the internal-shape library primarily represents the internal structure of a part.

[6. Process Flow]

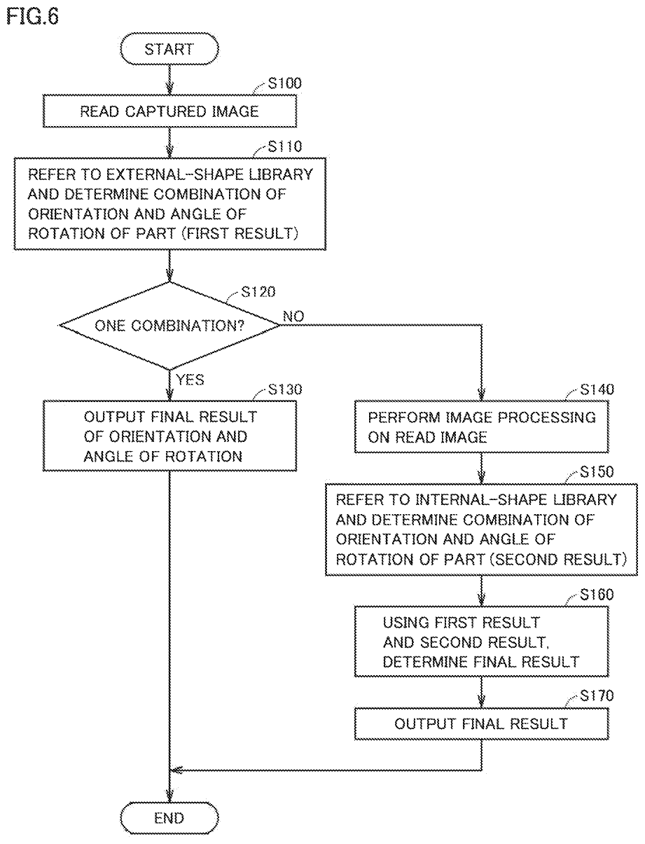

FIG. 6 is a flowchart of a process performed by the recognition apparatus 100 for outputting parts information of the part 400 placed on the tray 300. In one implementation, the recognition apparatus 100 causes the CPU 101 to execute a given program, thereby implementing the process of FIG. 6. In other implementation, the recognition apparatus 100 includes one or more processors, instead of the CPU 101, and causes the one or more processors to execute a given program, thereby implementing the process of FIG. 6. The recognition apparatus 100 may specify a part ID to be processed, and then start the process of FIG. 6.

In step S100, the recognition apparatus 100 obtains the image captured by the camera 120. In one implementation, the captured image is generated by the camera 120 capturing an image of the part 400 on the tray 300, and stored in the RAM 102 or the storage 103.

In step S110, the recognition apparatus 100 refers to the external-shape library and determines a combination of the orientation and the angle of rotation of the part.

More specifically, the recognition apparatus 100 extracts an element corresponding to a part from the image captured in step S100. The recognition apparatus 100 then matches the shape of the extract element with image patterns registered with the external-shape library and determines an image pattern that matches the extracted element. If the match rate is greater than or equal to a given value between the element extracted as noted above and an image pattern registered with the external-shape library, the recognition apparatus 100 may determine that the element corresponds to that image pattern. The recognition apparatus 100 then determines a combination of the orientation and the angle of rotation associated with the determined image pattern, as a combination of the orientation and the angle of rotation of the part captured in the captured image.

The recognition apparatus 100 may determine two or more combinations. For example, assume that a match rate is “80%” between the part and the image pattern corresponding to a combination of the orientation “FRONT” and the angle of rotation “15 degrees,” a match rate is “82%” between the part and the image pattern corresponding to a combination of the orientation “REAR” and the angle of rotation “15 degrees,” and the given value is “75%.” In this case, the recognition apparatus 100 determines that the part matches these two image patterns. The recognition apparatus 100 then determines the combinations of the orientation and the angle of rotation associated with these two image patterns, that is, two combinations, as combinations of the orientation and the angle of rotation of the part captured in the captured image.

In the following description, the combination determined in step S110 may also be referred to as a “first result.”

In step S120, the recognition apparatus 100 determines whether one combination is determined in step S110. If one combination is determined (YES in step S120), the recognition apparatus 100 passes the control to step S130. Otherwise, (NO in step S120), the recognition apparatus 100 passes the control to step S140.

In step S130, the recognition apparatus 100 outputs the combination determined in step S110, as the final result of the parts information, and ends the process of FIG. 6. The output may be displaying on the display 104 or transmitting to an external device (e.g., the robot arm 200).

In step S140, the recognition apparatus 100 performs image processing on the image read in step S100. In one implementation, the image processing converts the image captured for the purpose of recognition of the outer edge of the part into an image for the purpose of recognition the internal structure of the part. The image processing is applying gamma correction to the image, for example.

In step S150, the recognition apparatus 100 refers to the internal-shape library and determines a combination of the orientation and the angle of rotation of the part.

More specifically, the recognition apparatus 100 extracts an element corresponding to the part from the image having through the image processing performed in step S140. The recognition apparatus 100 matches the shape of the extract element with image patterns registered with the internal-shape library to determine an image pattern that matches the extracted element. The recognition apparatus 100 then determines a combination of the orientation and the angle of rotation associated with the determined image pattern, and a combination of the orientation and the angle of rotation of the part captured in the image. In the following description, the combination determined in step S150 may also be referred to as a “second result.”

In step S160, using the first result and the second result, the recognition apparatus 100 determines the final result of the parts information. In one implementation, the recognition apparatus 100 determines the image pattern having the highest match between the first result and the second result, and determines the combination of the orientation and the angle of rotation associated with that image pattern, as a final result.

For example, assume that the first result shows that the match rate is 80% between the element extracted from the captured image and the image pattern associated with “ANGLE OF ROTATION: ZERO DEGREE, ORIENTATION: FRONT,” and the match rate is 82% between the element extracted from the captured image and the image pattern associated with “ANGLE OF ROTATION: ZERO DEGREE, ORIENTATION: REAR.” In contrast, assume that the second result shows that the match rate is 10% between the element extracted from the captured image and the image pattern associated with “ANGLE OF ROTATION: ZERO DEGREE, ORIENTATION: FRONT,” the match rate is 90% between the element extracted from the captured image and the image pattern associated with “ANGLE OF ROTATION: ZERO DEGREE, ORIENTATION: REAR.” In this case, the image pattern associated with “ANGLE OF ROTATION: ZERO DEGREE, ORIENTATION: REAR” has the highest match rate between the first result and the second result. Accordingly, a combination of the angle of rotation “zero degree” and the orientation “REAR” is determined as the final result.

In step S170, similarly to step S130, the recognition apparatus 100 outputs the final result determined in step S160 and ends the process of FIG. 6.

[7. Variation (1)]

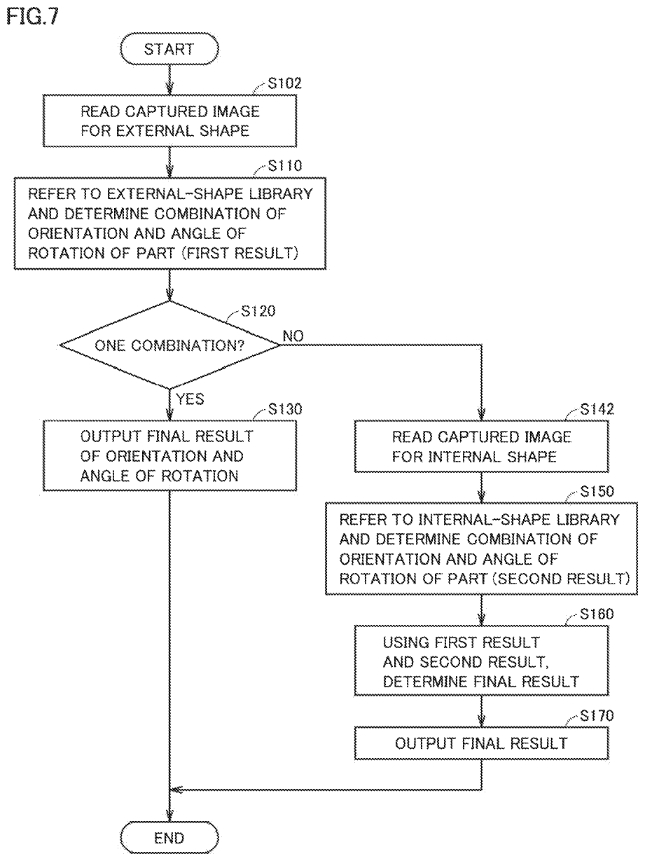

FIG. 7 is a flowchart of Variation 1 of the process of FIG. 6. In the process of FIG. 7, the captured image for use in step S150 is captured under imaging conditions different from those under which the image for use in step S110 is captured. For this reason, the process of FIG. 7 includes steps S102 and S142, instead of steps S100 and S140.

More specifically, in step S102, the recognition apparatus 100 reads a captured image for external shape. In step S110, the recognition apparatus 100 uses the captured image read in step S102.

In step S142, the recognition apparatus 100 reads a captured image for internal shape. In step S150, the recognition apparatus 100 uses the captured image read in step S142.

The camera 120 may capture the image (captured image for external shape) read in step S102 and the image (captured image for internal shape) read in step S142 under different imaging conditions. In one implementation, the camera 120 captures the captured image for internal shape under a longer exposure time, a higher gain, and/or higher lighting illuminance (brighter environment) than the captured image for external shape. This can definitize both the contour of an element corresponding to a part in the captured image for external shape, and the internal structure of a part in the captured image for internal shape.

[8. Variation (2)]

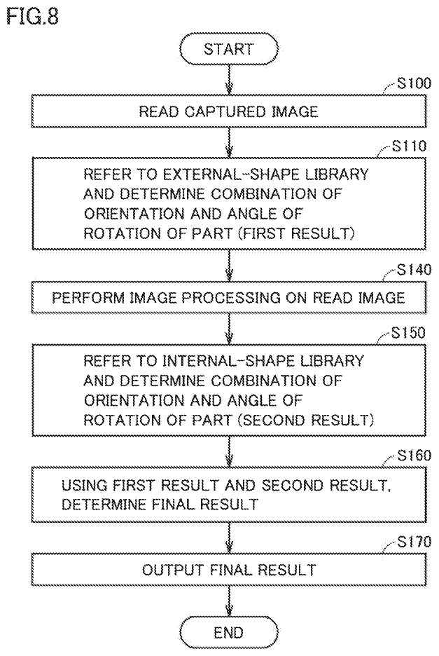

FIG. 8 is a flowchart of Variation 2 of the process of FIG. 6. In the process of FIG. 8, steps S120 and S130 are omitted, as compared to the process of FIG. 6. In other words, in the process of FIG. 8, the recognition apparatus 100 performs the controls of steps S140 to S170, even if only one combination is determined in step S110.

Note that, in step S150, the recognition apparatus 100 may determine “ORIENTATION” among the parts information items. If the outer edge of the front of the part is the same or very similar to the outer edge of the rear of the part, the first result determined in step S110 can be two combinations, including a combination defining a certain angle of rotation of the part and a combination defining the rear of the part at that angle of rotation. In such a case, insofar as the recognition apparatus 100 determines at least “ORIENTATION” in the parts information in step S150, the recognition apparatus 100 can determine the final combination by selecting one of the two combinations that includes the determined “ORIENTATION.”

[9. Variation (3)]

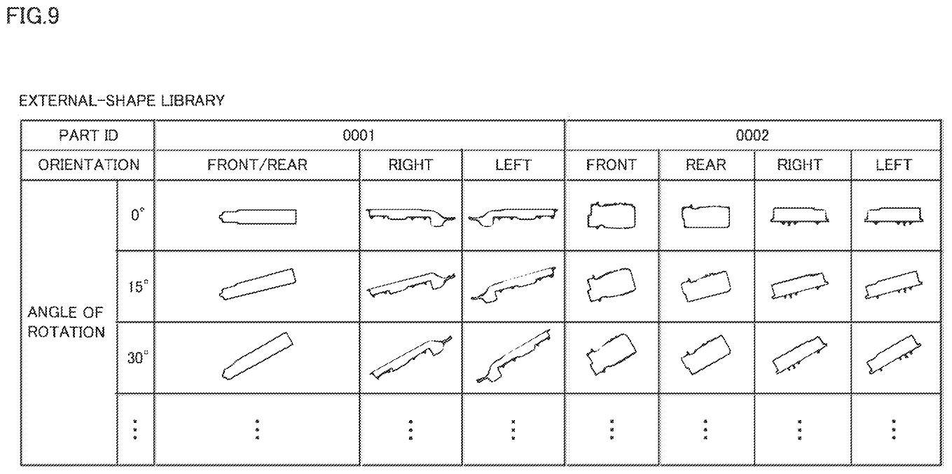

FIG. 9 is a diagram showing a variation of the data structure of the external-shape library. In the example of FIG. 9, compared to the example of FIG. 4, all the angles of rotation referred to by the part ID “0001” are associated with the same image pattern, with the orientations “FRONT” and “REAR” being unrecognizable from each other. This corresponds to the part determined by the part ID “0001” has an outer edge that is common to the front and the rear of the part.

If a match rate is high between the element in the captured image and the image pattern associated with the front and the rear in the external-shape library, the recognition apparatus 100 determines two combinations that are associated with that image pattern. For example, the two combinations are “ANGLE OF ROTATION: ZERO DEGREE, ORIENTATION: FRONT” and “ANGLE OF ROTATION: ZERO DEGREE, ORIENTATION: REAR.” In step S150, the recognition apparatus 100 selects a combination having a higher match rate in the second result between the two combinations, as the final result.

Although embodiments of the present invention have been described and illustrated in detail, the disclosed embodiments are made for purposes of illustration and example only and not limitation. The scope of the present invention should be interpreted by terms of the appended claims

What is claimed is:

1. An object recognition apparatus for recognizing a state of an object, the object recognition apparatus comprising:
a storage device; and
one or more processors that execute a program stored in the storage device, wherein
the one or more processors:
recognizes an external shape of the object, based on an image captured of the object,
recognizes an internal shape of the object, based on the image captured of the object; and
determines the state of the object, using a result of recognition of the external shape and a result of recognition of the internal shape.

2. The object recognition apparatus according to claim 1, wherein
the image used for the recognition of the external shape is a first image captured of the object, and
the image used for the recognition of the internal shape is a second image obtained by given image processing on the first image.

3. The object recognition apparatus according to claim 1, wherein
the image used for the recognition of the external shape is a first image captured of the object, and
the image used for the recognition of the internal shape is a second image captured of the object under imaging conditions different from imaging conditions under which the first image is captured.

4. The object recognition apparatus according to claim 1, wherein
the state of the object includes an orientation and an angle of rotation of the object.

5. The object recognition apparatus according to claim 4, wherein
the orientation and the angle of rotation of the object are recognized in the recognition of the external shape and the recognition of the internal shape.

6. The object recognition apparatus according to claim 5, wherein
the storage device stores:
an external-shape library in which an image pattern of the external shape of the object is associated with the orientation and the angle of rotation of the object; and
an internal-shape library in which an image pattern of the internal shape of the object is associated with the orientation and the angle of rotation of the object, wherein
the orientation and the angle of rotation of the object are recognized in the recognition of the external shape, based on a match rate between an element included in the image captured of the object and the image pattern included in the external-shape library, and
the orientation and the angle of rotation of the object are recognized in the recognition of the internal shape, based on a match rate between the element included in the image captured of the object and the image pattern included in the internal-shape library.

7. The object recognition apparatus according to claim 4, wherein
the orientation and the angle of rotation of the object are recognized in the recognition of the external shape,
the orientation of the object recognized by the recognition of the external shape includes two or more orientations, and
one of the two or more orientations is determined in the recognition of the internal shape.

8. The object recognition apparatus according to claim 7, wherein
the storage device stores:
an external-shape library in which an image pattern of the external shape of the object is associated with the orientation and the angle of rotation of the object; and
an internal-shape library in which an image pattern of the internal shape of the object is associated with the orientation and the angle of rotation of the object, wherein
two or more orientations are associated with one angle of rotation in the external-shape library,
the angle of rotation of the object is recognized in the recognition of the external shape, based on a match rate between an element included in the image captured of the object and the image pattern included in the external-shape library, and
the orientation of the object is recognized in the recognition of the internal shape, based on a match rate between the element included in the image captured of the object and the image pattern included in the internal-shape library.

9. The object recognition apparatus according to claim 1, further comprising
a camera for capturing the image of the object.

10. A non-transitory recording medium storing a computer readable program, which, when executed by a computer, causes the computer to perform steps, comprising:
recognizing an external shape of an object, based on an image captured of the object;
recognizing an internal shape of the object, based on the image captured of the object; and
determining a state of the object, using a result of recognition of the external shape and a result of recognition of the internal shape.
